(19) United States
(12) Patent Application Publication
(10) Pub. No.: US 2026/0112181 A1
(43) Pub. Date: Apr. 23, 2026

(54) SYSTEMS AND METHODS FOR MONITORING AND DETECTING AN UNSTABLE LOAD

(71) Applicant: Verizon Patent and Licensing Inc., Basking Ridge, NJ (US)

(72) Inventors: Tommaso MUGNAI, Florence (IT); David DI LORENZO, Florence (IT); Giovanni PINI, Firenze (IT); Filippo VALENTE, Sesto Fiorentino (IT); Francesco DE FELICE, Firenze (IT)

(21) Appl. No.: 18/918,473

(22) Filed: Oct. 17, 2024

(51) Int. Cl. G06V 20/59; G06V 10/75; G06V 10/764; G06V 10/77; G06V 10/82; G06V 20/40; G06V 20/56; G06V 20/70; G09B 19/16

(52) U.S. Cl. CPC G06V 20/59; G06V 10/759; G06V 10/764; G06V 10/7715; G06V 10/82; G06V 20/44; G06V 20/588; G06V 20/70; G09B 19/167

(57) ABSTRACT

A device may receive cargo data associated with cargo, and may segment one or more objects identified in the cargo data to generate image segments. The device may process the image segments, with a first model, to determine a first stability of the one or more objects, and may process the image segments, with a second model, to determine a second stability of the one or more objects. The device may combine the first stability and the second stability to generate a third stability, and may utilize a large language model with the image segments and one of the first stability, the second stability, or the third stability to generate a description of the one or more objects. The device may perform one or more actions based on one or more of the description, the first stability, the second stability, or the third stability.

### BACKGROUND

Transporting cargo safely and efficiently is an aspect of logistics and supply chain management. The securement of cargo in transit is not only a matter of efficiency and asset protection but also a significant safety concern. Inadequately secured cargo poses a risk of in-transit accidents, potentially leading to injuries, regulatory fines for non-compliance, and property damage.

### BRIEF DESCRIPTION OF THE DRAWINGS

FIGS. 1A-1H are diagrams of an example associated with monitoring and detecting an unstable load.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for monitoring and detecting an unstable load.

### DETAILED DESCRIPTION OF EXAMPLE EMBODIMENTS

The following detailed description of example implementations refers to the accompanying drawings. The same reference numbers in different drawings may identify the same or similar elements.

Unstable loads in warehouses, vehicles, in transit via motorized platforms, or the like are potentially dangerous and cost intensive, and thus preferable to mitigate. For example, operators and fleet managers face various challenges in ensuring cargo stability throughout transportation. Instances of disorganized cargo can delay operations and impact customer satisfaction with delivery delays and damaged goods. Additionally, when cargo items become unstable or fall, it becomes a cumbersome task to review video footage in its entirety to pinpoint when and how an incident occurred. Current cargo monitoring techniques are either insufficient or require attention that drivers cannot provide while focusing on the road. Thus, current techniques for monitoring cargo consume computing resources (e.g., processing resources, memory resources, communication resources, and/or the like), networking resources, and/or other resources associated with failing to accurately identify unstable cargo, utilizing the inaccurately identified unstable cargo to generate improper feedback and/or false alarms, handling in-transit accidents caused by unstable cargo, handling injuries, regulatory fines, and property damage caused by unstable cargo, and/or the like.

Some implementations described herein provide a video system that monitors and detects an unstable load. For example, the video system may receive cargo video data associated with cargo, and may segment one or more objects identified in the cargo video data to generate image segments. The video system may process the image segments, with a first model, to determine a first stability of the one or more objects, and may process the image segments, with a second model, to determine a second stability of the one or more objects. The video system may combine the first stability and the second stability to generate a third stability, and may utilize a large language model (LLM) with the image segments and one of the first stability, the second stability, or the third stability to generate a description of the one or more objects. The video system may perform one or more actions based on one or more of the description, the first stability, the second stability, or the third stability.

In this way, the video system monitors and detects an unstable load. For example, the video system may receive video data of cargo, may segment objects within the video data, and may process the segments through a model analysis to evaluate object stability. A model analysis involves application of a first model, a second model, or a combination of the first and second models to independently assess stability. The video system may integrate the assessments of the first model, the second model, or the combination of the first and second models to calculate a stability measure for the cargo. Additionally, the video system may utilize an LLM to produce an analysis of the cargo's condition and stability parameters. The video system may perform actions, such as sending automated alerts or modifying assessment protocols, in response to the stability evaluations. Thus, the video system may conserve computing resources, networking resources, and/or other resources that would have otherwise been consumed by failing to accurately identify unstable cargo, utilizing the inaccurately identified unstable cargo to generate improper driver feedback and/or false alarms, handling in-transit accidents caused by unstable cargo, handling injuries, regulatory fines, and property damage caused by unstable cargo, and/or the like.

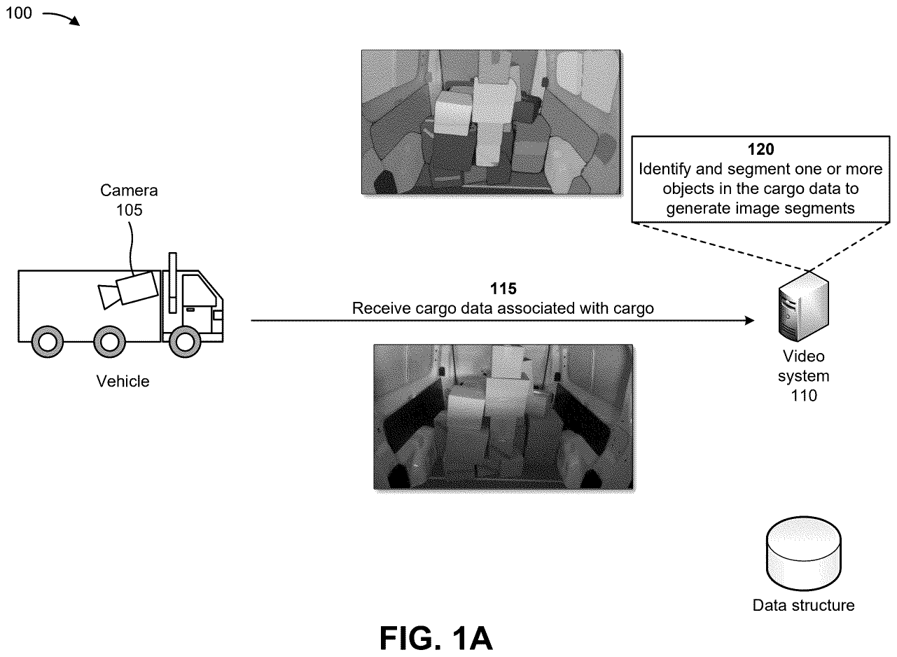

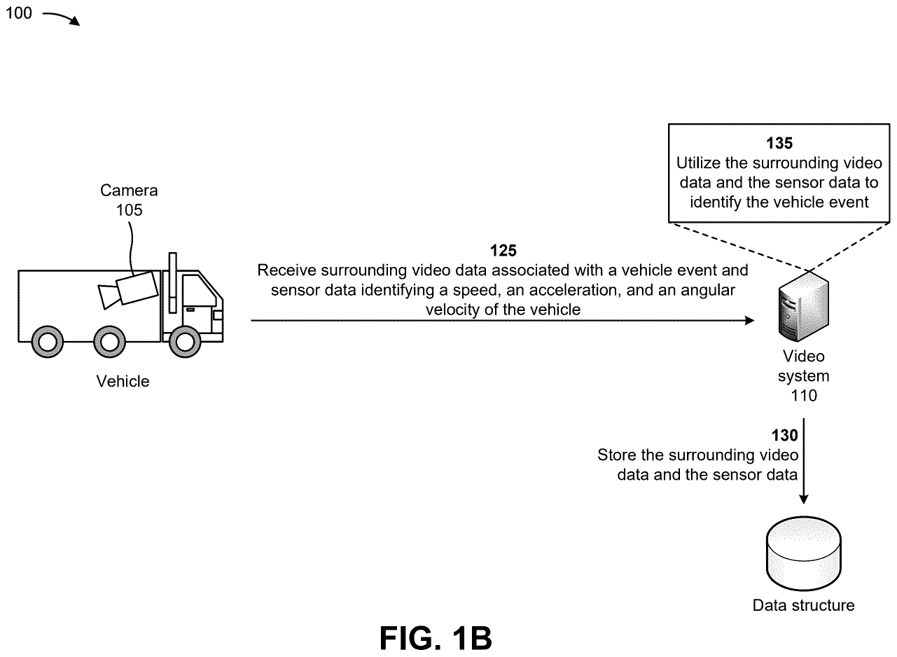

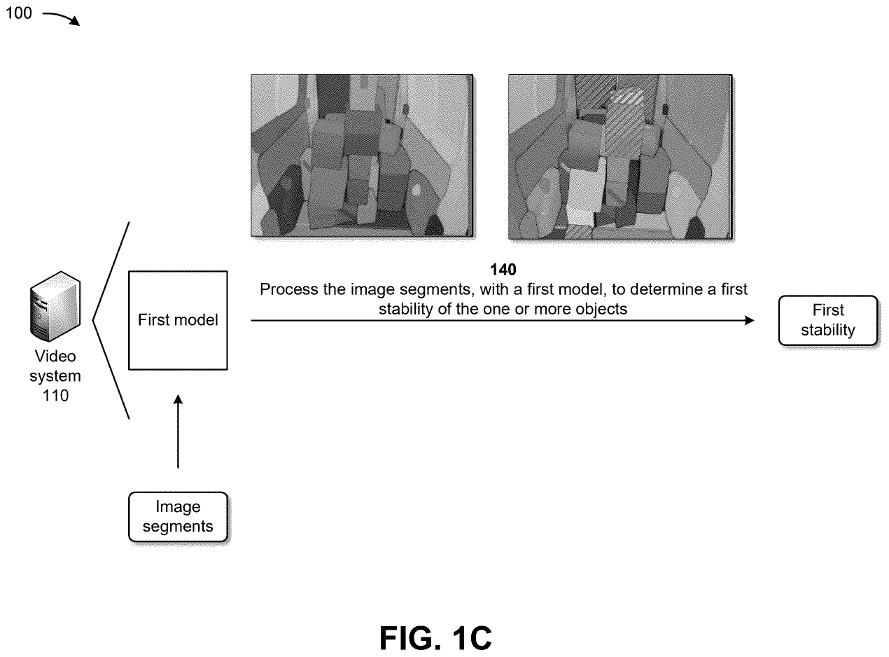

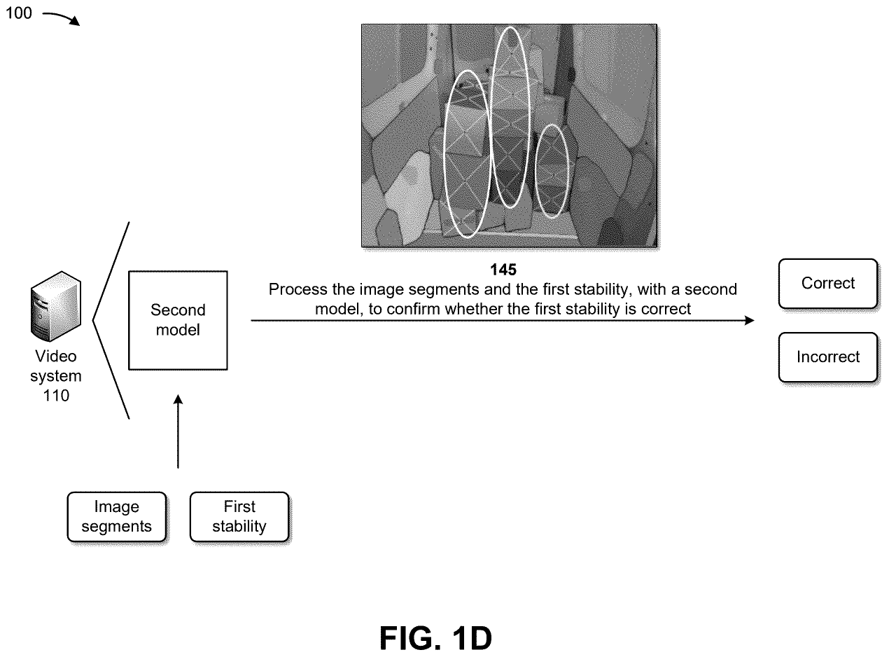

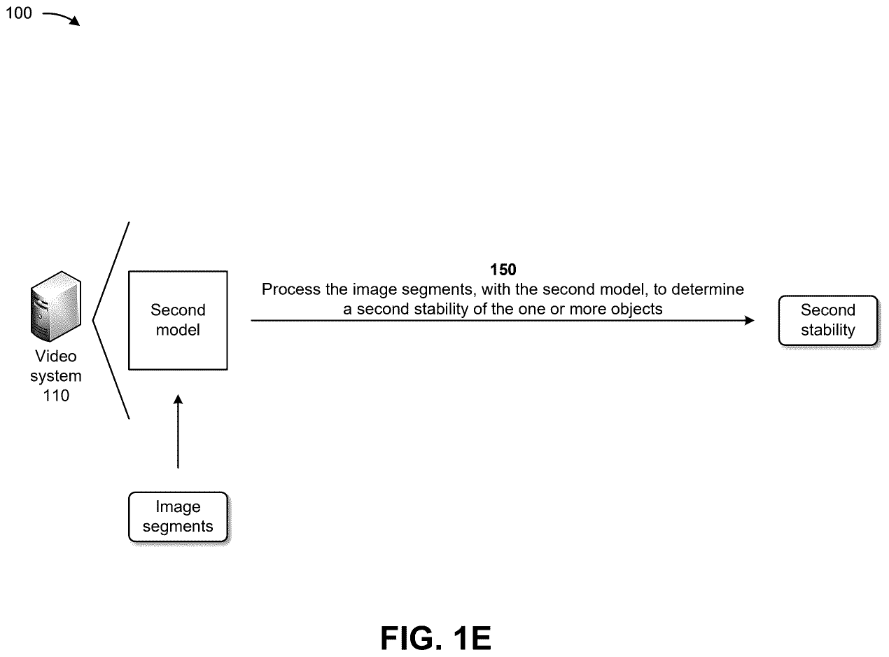

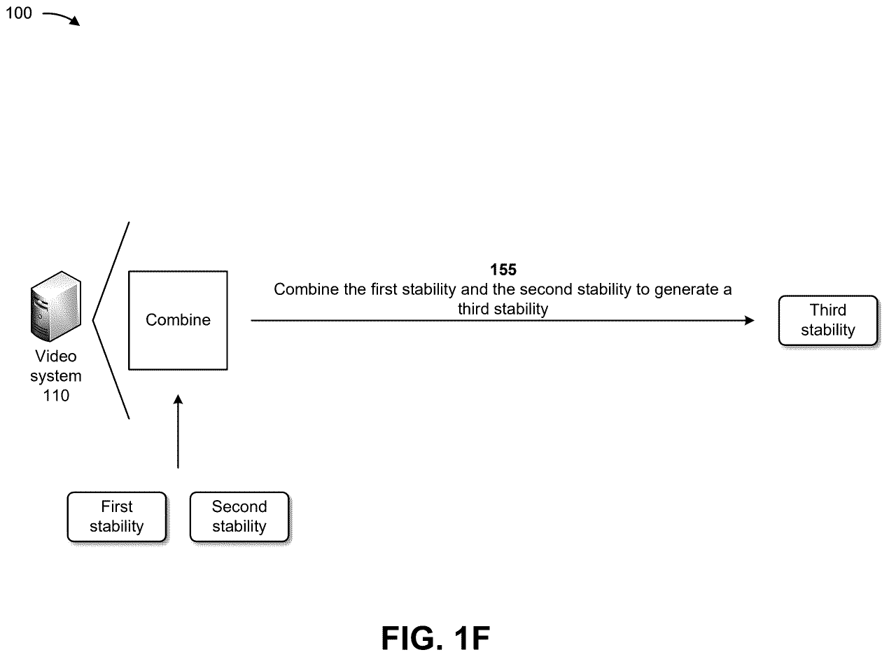

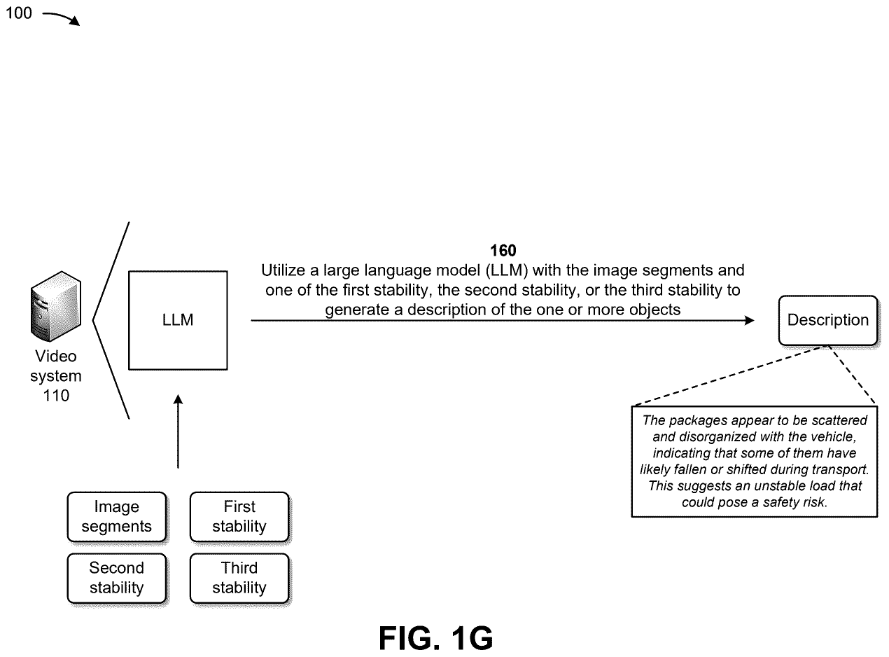

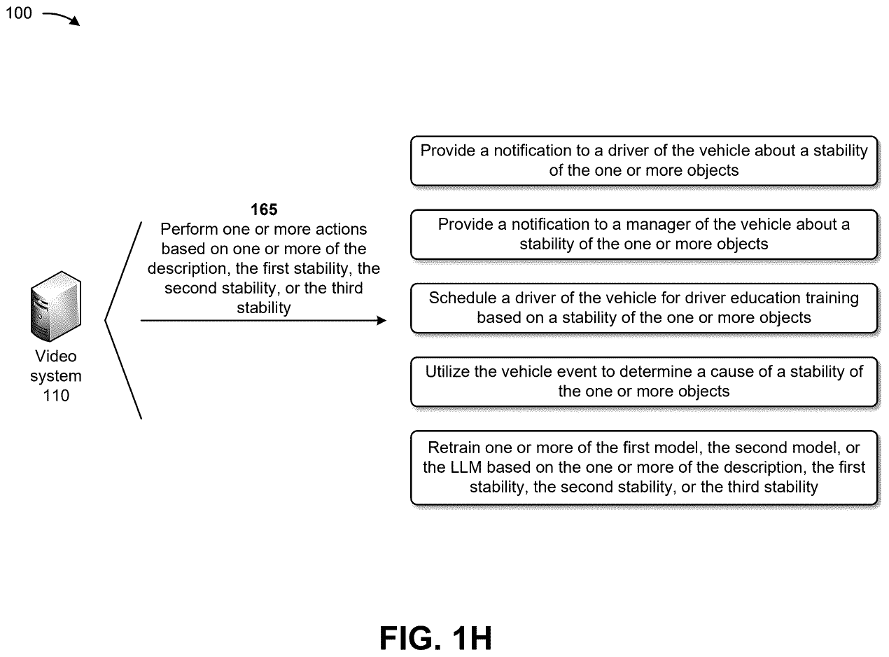

FIGS. 1A-1H are diagrams of an example 100 associated with monitoring and detecting an unstable load. As shown in FIGS. 1A-1H, the example 100 includes a camera 105 and a data structure associated with a vehicle and a video system 110. The camera 105 may capture video of objects (e.g., packages, cargo, pedestrians, traffic signs, traffic signals, road markers, a driver, animals, and/or the like) associated with the vehicle. The camera 105 may include a cargo camera of the vehicle, a dashcam of the vehicle, a forward-facing camera of the vehicle, a driver-facing camera of the vehicle, a side camera of the vehicle, a rear camera of the vehicle, and/or the like. The data structure may include a database, a table, a list, and/or the like that stores training data. The video system 110 may include a system that monitors and detects an unstable load of the vehicle. Further details of the camera 105, the data structure, the vehicle, and the video system 110 are provided elsewhere herein. Although implementations described herein depict a single vehicle, in some implementations, the video system 110 may be associated with multiple vehicles.

As shown by FIG. 1A, and by reference number 115, the video system 110 may receive cargo video data associated with cargo. For example, the camera 105 may capture the cargo video data identifying the cargo inside the vehicle, and may provide the cargo video data to the video system 110, and the video system 110 may receive the cargo video data. The cargo video data may include images or videos of the cargo inside the vehicle. In some implementations, the camera 105 may periodically capture the cargo video data, and may provide the cargo video data to the video system 110. For example, the camera 105 may capture a frame every few seconds or minutes to monitor the cargo's stability and condition. In some implementations, the video system 110 may continuously receive the cargo video data from the camera 105, may periodically receive the cargo video data from the camera 105, may receive the cargo video data from the camera 105 based on requesting the cargo video data, and/or the like. In some implementations, the cargo data may not include video data, but rather may include multiple images of the cargo captured by the camera 105 over a time period.

As further shown in FIG. 1A, and by reference number 120, the video system 110 may identify and segment one or more objects in the cargo video data to generate image segments. For example, the video system 110 may analyze the cargo video data using object detection models to identify distinct objects within the cargo area, such as boxes, containers, or packages. The video system 110 may then segment the identified objects into separate image segments, where each segment represents an individual object within the cargo area. In some implementations, the video system 110 may utilize object recognition models (e.g., deep learning-based models) to analyze the cargo video data and pinpoint discrete items in the vehicle. The video system 110 may then segment the identified objects into separate image segments. Each image segment may be tagged or labeled for easy identification in subsequent processes, and each image segment may represent an individual object within the cargo. In some implementations, the video system 110 may use advanced segmentation models, such as machine learning models or artificial intelligence models, to accurately segment the objects even in complex or cluttered cargo environments.

In some implementations, the video system 110 may store the image segments in a data structure, such as a database, a list, or a table within the video system 110. The data structure may be used to track and analyze the stability and condition of the objects over time, identifying any changes or movements that might indicate instability or potential issues. For example, the video system 110 may compare the image segments captured at different times to detect any significant movement or rotation of the cargo objects, thereby identifying any potential instability.

As shown in FIG. 1B, and by reference number 125, the video system 110 may receive surrounding video data associated with a vehicle event and sensor data identifying a speed, an acceleration, and an angular velocity of the vehicle. For example, one or more of the cameras 105 associated with the vehicle may continuously capture the surrounding video data associated with the vehicle experiencing the vehicle event. The vehicle may also be associated with a global positioning system (GPS) sensor that captures the speed of the vehicle experiencing the vehicle event, and an inertial measurement unit (IMU) sensor that captures the acceleration and the angular velocity of the vehicle experiencing the vehicle event. The signals captured by the GPS sensor and the IMU sensor may correspond to the sensor data identifying the speed, the acceleration, and the angular velocity of the vehicle. In some implementations, the video system 110 may periodically receive the surrounding video data associated with the vehicle experiencing the vehicle event and the sensor data identifying the speed, the acceleration, and the angular velocity of the vehicle; may continuously receive the surrounding video data and the sensor data; may receive the surrounding video data and the sensor data based on requesting the surrounding video data and the sensor data from the vehicle, and/or the like.

The video system 110 may receive the surrounding video data from the cameras 105 mounted on and/or in the vehicle, and may receive the sensor data from the sensors mounted on the vehicle. The surrounding video data may provide visual context, and the sensor data may provide quantitative measurements regarding dynamics of the vehicle during the vehicle event. The sensor data may enable the video system 110 to assess maneuvers of the vehicle and possible driving events (e.g., harsh braking or rapid acceleration) which may be indicative of near-crash or crash scenarios. The incorporation of the sensor data allows for a more nuanced analysis by providing additional dimensions to contextual information gathered from the surrounding video data alone. This may enhance the overall capability of the video system 110 to detect and categorize driving events with greater accuracy.

In some implementations, the video system 110 may receive the surrounding video data from multiple dashcams installed in various positions within the vehicle to provide multiple perspectives of the vehicle event. This enhances an ability of the video system 110 to understand the vehicle event from all angles, offering a more detailed and comprehensive analysis. Additionally, or alternatively, the surrounding video data may be generated by exterior cameras mounted on the vehicle to capture surrounding traffic conditions. This may be particularly useful for assessing the vehicle's interaction with an environment, capturing events, such as near-miss incidents or minor collisions, that may not be as clearly depicted by internal cameras. Additionally, or alternatively, the surrounding video data may also include thermal imaging to capture more detail in low-visibility conditions. Thermal imaging can be beneficial in foggy, smoky, or nighttime scenarios, where standard cameras might miss crucial information.

In some implementations, the sensor data may include additional parameters beyond speed, acceleration, and angular velocity, such as tire traction levels, steering angle, and brake pressure. Including these parameters may provide the video system 110 with a more nuanced understanding of the vehicle's state and how the driver is interacting with the vehicle controls during the vehicle event. Additionally, or alternatively, the sensor data may be coupled with environmental data, such as weather conditions from external weather services, which may influence vehicle dynamics. Environmental data may often play a critical role in vehicular events, and accounting for environmental data may significantly improve the analysis accuracy. Additionally, or alternatively, additional data may be obtained not only from onboard vehicle diagnostics, but also from connected infrastructure like smart traffic systems for a broader understanding of the vehicle event. Utilizing connected infrastructure data may provide contextual information that may otherwise be unavailable, such as a state of nearby traffic lights or congestion levels, which could influence the vehicle behavior and the vehicle event outcome.

As further shown in FIG. 1B, and by reference number 130, the video system 110 may store the surrounding video data and the sensor data in the data structure. For example, the video system 110 may receive the surrounding video data and the sensor data associated with the vehicle event and may store this data in the data structure associated with the video system 110. Storing the surrounding video data and sensor data may enable subsequent processing and analysis by the video system 110, may aid in tracking and monitoring the stability and condition of the cargo, and may provide a historical record of vehicle events. Additionally, or alternatively, the video system 110 may store the surrounding video data and the sensor data in cloud-based storage. Cloud storage offers scalability and remote access, which is beneficial for fleet operators managing multiple vehicles.

As further shown in FIG. 1B, and by reference number 135, the video system 110 may utilize the surrounding video data and the sensor data to identify the vehicle events. For example, the video system 110 may process the surrounding video data and the sensor data to determine the occurrence of specific vehicle events, such as harsh braking, rapid acceleration, or near-crash scenarios, which may impact the stability of the cargo. By analyzing the sensor data identifying the speed, acceleration, and angular velocity of the vehicle, in conjunction with the visual context provided by the surrounding video data, the video system 110 can accurately identify and categorize vehicle events. This identification process can trigger further actions by the video system 110, such as alerting a driver about an unstable load or notifying fleet managers of potential issues, thereby ensuring cargo safety and compliance. In some implementations, the video system 110 may utilize pattern recognition models to detect the vehicle events, such as sudden stops, swerves, or risky driving behaviors that could affect cargo stability. Additionally, or alternatively, the video system 110 may utilize machine learning models to interpret the surrounding video data and the sensor data to classify vehicle events.

As shown in FIG. 1C, and by reference number 140, the video system 110 may process the image segments, with a first model, to determine a first stability of the one or more objects. For example, the video system 110 may analyze each image segment to identify potential instability indicators using an object detection model and a similarity function, such as the intersection over union (IoU) calculation. The intersection over union may be calculated as follows:

$$IoU ( segment1 , segment2 ) = \frac{\begin{matrix}number of pixels that belong to \\ both segment 1 and segment 2\end{matrix}}{\begin{matrix}number of pixels that belong to \\ either segment 1 and segment 2\end{matrix}} .$$

The similarity function may compare each image segment from two frames to determine an extent of movement or stability based on overlap and shape consistency. If two segments have a high similarity score (e.g., an loU approximately equal to one), it may indicate stability; if the similarity score is low (e.g., an loU approximately equal to zero), it signifies possible instability or movement.

In some implementations, the video system 110 may utilize the first model to filter and clean the image segments by removing segments containing a number of pixels below a threshold (e.g., one thousand pixels) that depends on image resolution. After filtering the image segments, the first model may recenter the image segments to account for camera movement (e.g., which may generate an instability determination for the cargo). For example, the first model may repeatedly attempt to slightly shift one of the image segments until the similarity function for most of the image segments keeps increasing. In particular, if dx and dy are a current shift in pixels, the first model may start with dx=0 and dy=0. The first model may determine a list of matches by executing a matching step, described below. A joining step, also described below, may also be executed before the matching step, which may provide additional accuracy. The first model may utilize a top percentage (e.g., a top 80%) of the matches in the list to compute an average of the similarity function for the top percentage matches. The first model may perform the following steps multiple times, each time increasing or decreasing either dx or dy by one with respect to a previous value: (1) shift a second image segment on the horizontal axis by dx, and on the vertical axis by dy; (2) compute an average of the similarity function for the top percentage matches for the shifted image; (3) if the average is lower than the previous similarity average, then utilize the average as a new average and return to step (1); and (4) otherwise, terminate the steps and shift the image segment according to the last dx and dy values. The top percentage matches are utilized, instead of utilizing all of the matches, because there may be some movement in the cargo as well as the camera 105. For example, when something moves in the cargo area, less than 20% of the image segments may be affected, so the top 80% are considered to ensure that the moving image segments do not affect the calculation for the camera-related shift.

The first model may group or join closely located image segments to accurately reflect the actual objects in the cargo. This may aid in minimizing false positives caused by camera vibrations or minor shifts in the cargo. A single object may be erroneously split into more than one image segment depending on external conditions. For example, half of an object might be lighted, and half might be dark, and an image segment may incorrectly determine that those are two different objects. Furthermore, this erroneous splitting may be different from one frame to a next frame. In order to mitigate this problem, the first model may determine whether any two image segments in the same image, once joined, would correspond to another image segment in another frame. The first model may perform the following steps to address this problem: (1) select one of two images; (2) within the selected image, determine all pairs of segments that are close to one another; (3) for each pair, analyze a segment obtained by merging the two segments; (4) select all segments from the unselected image which overlap with the merged segment; (5) for every such segment, determine whether the merged segment and the overlapping segment are similar, and if so, merge the segments in the original image; (6) return to step 1 and select the other of the two original images; (7) if, during either of the two previous executions, some segments have been merged in step 5, then execute the steps again, because this could allow additional segments to be merged; and (8) otherwise end the process.

After joining closely located image segments to accurately reflect the actual objects in the cargo, the first model may perform a matching step to determine which segments in a first image correspond to segments (if any) in a second image. The matching step may include the following steps: (1) for every pair of segments, such that a first segment belongs to a first image, and a second segment belongs to the second image, compute the similarity function; (2) sort all pairs from a highest similarity to a lowest similarity based on results of the similarity function and generate a list; (3) select a first pair from the list and match the two segments (e.g., and mark the two segments as already matched); and (4) continue matching the segments in order, but skip the pairs in which one (or both) of the segments are already matched. Once the list has been processed, the first model may output a set of matches. If all of the segments are similar to the corresponding segments in the other image, the first model may determine that nothing has moved within the cargo (e.g., that the objects are stable). Otherwise, the first model may determine that one or more objects within the cargo have moved (e.g., that the objects are unstable).

In some implementations, processing the image segments, with the first model, to determine the first stability of the one or more objects may include the video system 110 utilizing the first model to ascertain a preliminary stability of each object. This may involve employing object detection techniques and similarity functions like pixel-to-pixel correlation to compare image segments across frames. Additionally, or alternatively, processing the image segments, with the first model, to determine the first stability of the one or more objects may include the video system 110 executing a preliminary analysis of the segmented images utilizing a stability assessment model. This involves measuring a degree of positional continuity between frames to identify any significant movement of objects. Additionally, or alternatively, processing the image segments, with the first model, to determine the first stability of the one or more objects may include the video system 110 performing an initial stability assessment using the first model, which processes the segmented images and compares them using spatial analysis metrics like the intersection over union or other similarity scores to detect consistent patterns that indicate stability.

As shown in FIG. 1D, and by reference number 145, the video system 110 may process the image segments and the first stability, with a second model, to confirm whether the first stability is correct. For example, the video system 110 may utilize the first model to quickly generate the first stability of the one or more objects, and may utilize the second model (e.g., a center-of-mass model) to confirm an accuracy of the first stability generated by the first model. In some implementations, the first model may provide a low cost, high speed, and low accuracy determination of the stability of the cargo, and the second model may provide a more expensive, slower, and higher accuracy determination of the stability of the cargo.

As shown in FIG. 1E, and by reference number 150, the video system 110 may process the image segments, with the second model, to determine a second stability of the one or more objects. For example, the video system 110 may utilize the second model (e.g., a center-of-mass model) to determine the second stability of the one or more objects based on the image segments. The second model may utilize the filtering and joining steps of the first model on a pair of images in order to pair corresponding image segments in both images. The second model may compute a center of mass of the objects as an average coordinate of a corresponding segment. The second model may group and sort (e.g., from bottom to top) objects in a same stack, and may compute an angle between two consecutive objects in the same group. The second model may compute a difference of angles between two image frames and may utilize the difference of angles to determine whether groups are unstable. For example, the second model may utilize absolute checks or comparisons with other stacks in the image (e.g., a standard deviation).

In some implementations, the second model may utilize a center-of-mass analysis and may compute a stability measure based on the calculated center of mass and observed shifts from one frame to another. For example, the second model may track the center of mass for each object across a series of frames to identify any significant shifts in position that indicate instability. Additionally, or alternatively, the second model may calculate vectors representing distances and directions between centers of mass across consecutive frames, and may use the vectors to assess the stability of the cargo. Additionally, or alternatively, the second model may create a virtual grid overlay on the image, and may assign stability scores to each grid section based on object movements between frames. Additionally, or alternatively, the second model may calculate a movement trajectory for each object to assess any significant deviations or instability. For example, a trajectory of each object may be mapped and analyzed to detect abrupt or irregular movements. In some implementations, the video system 110 may cross- reference stability assessments from the first model and/or the second model with vehicle event data, such as harsh braking or sharp turns, to enhance accuracy. In doing so, the system can better contextualize the stability data by considering external factors that may influence cargo stability.

As shown in FIG. 1F, and by reference number 155, the video system 110 may combine the first stability and the second stability to generate a third stability. For example, if the performances of the first model and the second model are similar, the video system 110 may combine the first stability generated by the first model with the second stability generated by the second model to provide a combined stability (e.g., the third stability) with higher accuracy. In some implementations, the video system 110 may combine the first stability (stability1) and the second stability (stability2) to generate the third stability (stability), as follows:

$$Stability = alpha1 * ( 1 + stability1 ) * accuracy1 + alpha2 * ( 1 + stability2 ) * accuracy2 ,$$

where stability1 and stability2 are equal to one (1) if the cargo is stable and zero (0) if the cargo unstable; accuracy1 and accuracy2 are accuracies of the models from 0 to 1; and alpha1 and alpha2 are weight coefficients assigned to the models (e.g., could be 0.5, to give equal weights). By tuning the alpha parameters and defining a threshold for the stability value (e.g., to provide high confidence), an optimum combination may be found and both models may be utilized to provide an enhanced result.

As shown in FIG. 1G, and by reference number 160, the video system 110 may utilize an LLM with the image segments and one of the first stability, the second stability, or the third stability to generate a description of the one or more objects. For example, the video system 110 may use the LLM to analyze the image segments and the calculated stabilities (e.g., first, second, or third) to generate detailed descriptions of the identified objects in the cargo. The LLM may analyze the visual data and contextual stability information to produce a narrative that provides insights into the status and stability of the cargo. This narrative may include observations about the arrangement, positioning, and potential movements of the objects. For example, as shown in FIG. 1G, the LLM may generate a description, such as “The packages appear to be scattered and disorganized with the vehicle, indicating that some of them have likely fallen or shifted during transport. This suggests an unstable load that could pose a safety risk.”

In some implementations, the LLM may identify specific objects considered unstable based on their image segments and stability measures. For example, the LLM may generate a description indicating that certain packages appear to be displaced or shifted within the cargo area, suggesting instability or potential hazards. In such scenarios, the LLM may utilize an understanding of the visual context and may apply predefined criteria to classify and describe the state of the cargo. In some implementations, the LLM may use text-to-speech technology to describe the cargo's state and stability directly to the driver regarding any immediate risks. This real-time feedback can enhance the driver's situational awareness, helping to prevent accidents related to cargo instability.

As shown in FIG. 1H, and by reference number 165, the video system 110 may perform one or more actions based on one or more of the description, the first stability, the second stability, or the third stability. In some implementations, performing the one or more actions includes the video system 110 providing a notification to a driver of the vehicle about an instability of the one or more objects. For example, this notification may be an audio alert, a visual alert on a dashboard monitor, or a message sent to the driver's mobile device, informing the driver that cargo in the vehicle has become unstable and may require attention to prevent a hazardous situation. In this way, the video system 110 conserves computing resources, networking resources, and/or other resources that would have otherwise been consumed by failing to accurately identify unstable cargo in a vehicle and failing to notify a driver of the vehicle.

In some implementations, performing the one or more actions includes the video system 110 providing a notification to a manager of the vehicle about an instability of the one or more objects. For example, the video system 110 may send an alert to a fleet manager's dashboard, email, or mobile device, indicating that specific cargo within a vehicle is unstable. This notification can help the fleet manager take corrective action, such as dispatching assistance or advising the driver on how to secure the cargo. In this way, the video system 110 conserves computing resources, networking resources, and/or other resources that would have otherwise been consumed by utilizing the inaccurately identified unstable cargo to generate improper driver feedback and/or false alarms.

In some implementations, performing the one or more actions includes the video system 110 scheduling a driver of the vehicle for driver education training based on an instability of the one or more objects. For example, if the video system 110 determines that instabilities are frequently caused by certain driving behaviors (e.g., sudden stops or sharp turns), the video system 110 may schedule the driver for training sessions aimed at improving driving habits to enhance cargo stability. In this way, the video system 110 conserves computing resources, networking resources, and/or other resources that would have otherwise been consumed by failing to address a driver causing unstable cargo in a vehicle.

In some implementations, performing the one or more actions includes the video system 110 utilizing the vehicle event to determine a cause of an instability of the one or more objects. For example, the video system 110 may analyze data from the vehicle's sensors, such as speed, acceleration, or angular velocity, along with video data, to pinpoint the cause of the cargo instability. This analysis can help in understanding whether the instability was due to external factors (e.g., sudden braking to avoid an obstacle) or driver behavior, thus providing valuable information for future preventive measures. In this way, the video system 110 conserves computing resources, networking resources, and/or other resources that would have otherwise been consumed by failing to address a driver causing unstable cargo in a vehicle.

In some implementations, performing the one or more actions includes the video system 110 retraining one or more of the first model, the second model, or the LLM based on the one or more of the description, the first stability, the second stability, or the third stability. For example, the video system 110 may utilize the one or more of the description, the first stability, the second stability, or the third stability as additional training data for retraining the one or more of the first model, the second model, or the LLM, thereby increasing the quantity of training data available for training the one or more of the first model, the second model, or the LLM. Accordingly, the video system 110 may conserve computing resources associated with identifying, obtaining, and/or generating historical data for training the one or more of the first model, the second model, or the LLM, relative to other systems for identifying, obtaining, and/or generating historical data for training machine learning models.

In this way, the video system 110 monitors and detects an unstable load. For example, the video system 110 may receive video data of a vehicle's cargo, may segment objects within the video data, and may process the segments through a model analysis to evaluate object stability. The model analysis involves application of a first model, a second model, or a combination of the first and second models to independently assess stability. The video system 110 may integrate the assessments of the first model, the second model, or the combination of the first and second models to calculate a stability measure for the cargo. Additionally, the video system 110 may utilize an LLM to produce an analysis of the cargo's condition and stability parameters. The video system 110 may perform actions, such as sending automated alerts or modifying assessment protocols, in response to the stability evaluations. Thus, the video system 110 may conserve computing resources, networking resources, and/or other resources that would have otherwise been consumed by failing to accurately identify unstable cargo in a vehicle, utilizing the inaccurately identified unstable cargo to generate improper driver feedback and/or false alarms, handling in-transit accidents caused by unstable vehicle cargo, handling injuries, regulatory fines, and property damage caused by unstable vehicle cargo, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

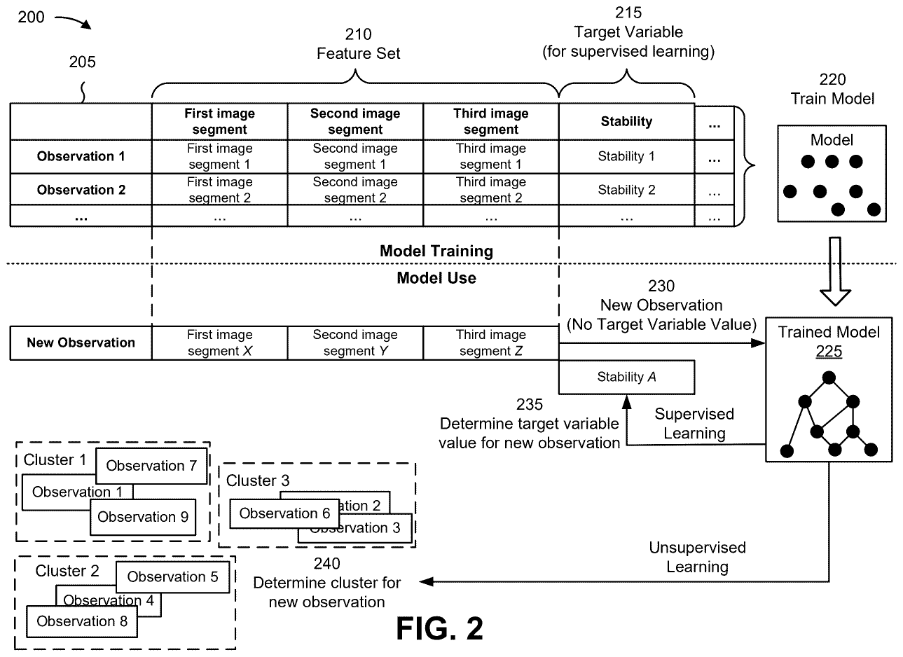

FIG. 2 is a diagram illustrating an example 200 of training and using a machine learning model for monitoring and detecting an unstable load. The machine learning model training and usage described herein may be performed using a machine learning system. The machine learning system may include or may be included in a computing device, a server, a cloud computing environment, and/or the like, such as the video system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the video system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the video system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of a first image segment, a second feature of a second image segment, a third feature of a third image segment, and so on. As shown, for a first observation, the first feature may have a value of a first image segment 1, the second feature may have a value of a second image segment 1, the third feature may have a value of a third image segment 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “stability” and may include a value of stability 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of a first image segment X, a second feature of a second image segment Y, a third feature of a third image segment Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of stability A for the target variable of the stability for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first image segment cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second image segment cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to monitor and detect an unstable load. The machine learning system enables recognition and/or identification of tens, hundreds, thousands, or millions of features and/or feature values for tens, hundreds, thousands, or millions of observations, thereby increasing accuracy and consistency and reducing delay associated with monitoring and detecting an unstable load relative to requiring computing resources to be allocated for tens, hundreds, or thousands of operators to manually monitor and detect an unstable load.

As indicated above, FIG. 2 is provided as an example. Other examples may differ from what is described in connection with FIG. 2.

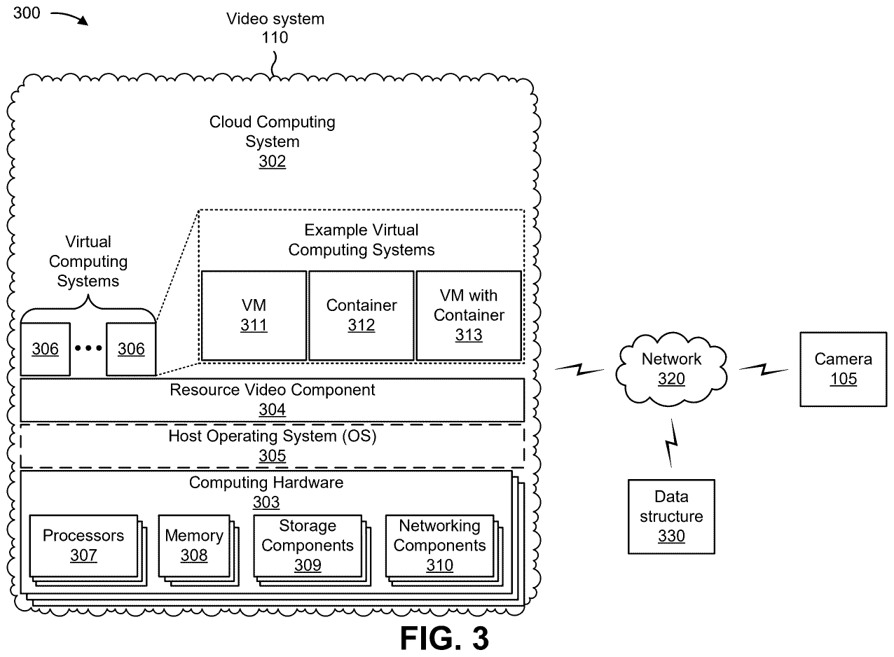

FIG. 3 is a diagram of an example environment 300 in which systems and/or methods described herein may be implemented. As shown in FIG. 3, the environment 300 may include the video system 110, which may include one or more elements of and/or may execute within a cloud computing system 302. The cloud computing system 302 may include one or more elements 303-313, as described in more detail below. As further shown in FIG. 3, the environment 300 may include the camera 105, a network 320, and/or a data structure 330. Devices and/or elements of the environment 300 may interconnect via wired connections and/or wireless connections.

The camera 105 may include one or more devices capable of receiving, generating, storing, processing, providing, and/or routing information, as described elsewhere herein. The camera 105 may include a communication device and/or a computing device. For example, the camera 105 may include an optical instrument that captures videos (e.g., images and audio). The camera 105 may feed real-time video directly to a screen or a computing device for immediate observation, may record the captured video (e.g., images and audio) to a storage device for archiving or further processing, and/or the like. In some implementations, the camera 105 may include a cargo camera of a vehicle, a dashcam of a vehicle, a forward facing camera of a vehicle, a driver facing camera of a vehicle, a side camera of a vehicle, a rear camera of a vehicle, and/or the like.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud- based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

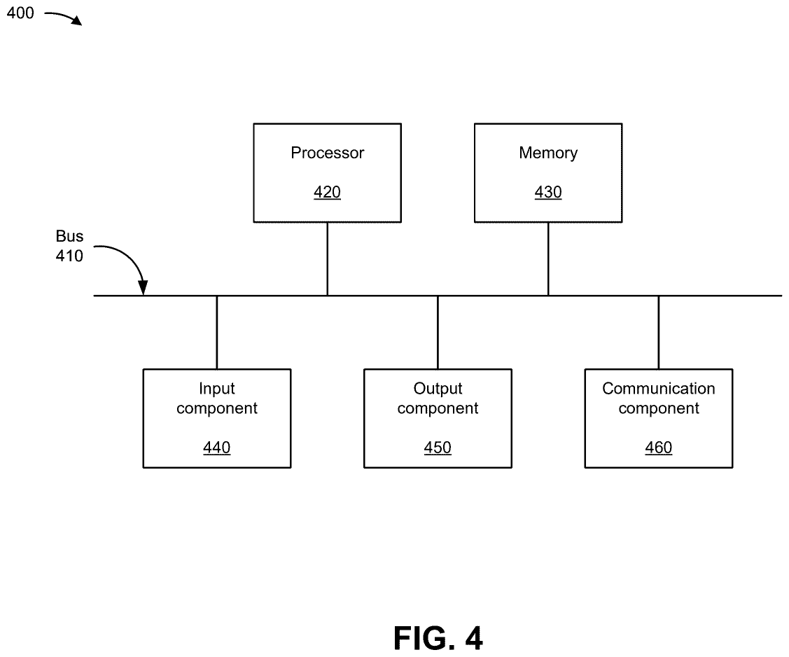

Although the video system 110 may include one or more elements 303-313 of the cloud computing system 302, may execute within the cloud computing system 302, and/or may be hosted within the cloud computing system 302, in some implementations, the video system 110 may not be cloud-based (e.g., may be implemented outside of a cloud computing system) or may be partially cloud-based. For example, the video system 110 may include one or more devices that are not part of the cloud computing system 302, such as a device 400 of FIG. 4, which may include a standalone server or another type of computing device. The video system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the camera 105, the video system 110, and/or the data structure 330. In some implementations, the camera 105, the video system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

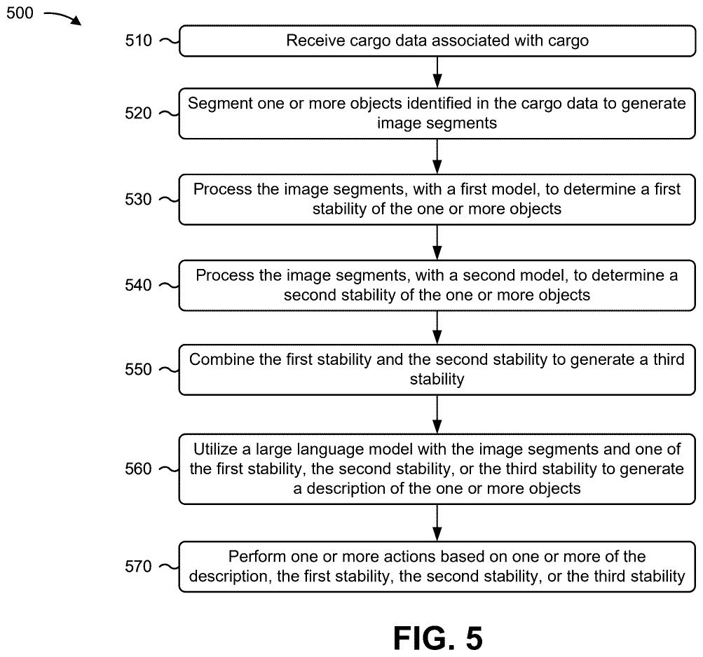

FIG. 5 depicts a flowchart of an example process 500 for monitoring and detecting an unstable load. In some implementations, one or more process blocks of FIG. 5 may be performed by a device (e.g., the video system 110). In some implementations, one or more process blocks of FIG. 5 may be performed by another device or a group of devices separate from or including the device, such as a control system of the vehicle, a camera (e.g., the camera 105), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving cargo data associated with cargo (block 510). For example, the device may receive cargo data associated with cargo, as described above.

As further shown in FIG. 5, process 500 may include segmenting one or more objects identified in the cargo data to generate image segments (block 520). For example, the device may segment one or more objects identified in the cargo data to generate image segments, as described above.

As further shown in FIG. 5, process 500 may include processing the image segments, with a first model, to determine a first stability of the one or more objects (block 530). For example, the device may process the image segments, with a first model, to determine a first stability of the one or more objects, as described above. In some implementations, processing the image segments, with the first model, to determine the first stability of the one or more objects includes filtering the image segments to remove one or more image segments, recentering the image segments to account for camera movement by a camera associated with the cargo, joining two of the image segments together that correspond to an object of the one or more objects, and matching the image segments, after filtering, recentering, and joining, to determine the first stability of the one or more objects. In some implementations, processing the image segments, with the first model, to determine the first stability of the one or more objects includes utilizing a similarity function to compare the image segments across multiple frames of the cargo data to determine the first stability of the one or more objects.

As further shown in FIG. 5, process 500 may include processing the image segments, with a second model, to determine a second stability of the one or more objects (block 540). For example, the device may process the image segments, with a second model, to determine a second stability of the one or more objects, as described above. In some implementations, processing the image segments, with the second model, to determine the second stability of the one or more objects includes utilizing a center-of-mass analysis with the image segments to calculate and compare angles associated with the one or more objects and to determine the second stability of the one or more objects based on the angles.

As further shown in FIG. 5, process 500 may include combining the first stability and the second stability to generate a third stability (block 550). For example, the device may combine the first stability and the second stability to generate a third stability, as described above.

As further shown in FIG. 5, process 500 may include utilizing an LLM with the image segments and one of the first stability, the second stability, or the third stability to generate a description of the one or more objects (block 560). For example, the device may utilize an LLM with the image segments and one of the first stability, the second stability, or the third stability to generate a description of the one or more objects, as described above.

As further shown in FIG. 5, process 500 may include performing one or more actions based on one or more of the description, the first stability, the second stability, or the third stability (block 570). For example, the device may perform one or more actions based on one or more of the description, the first stability, the second stability, or the third stability, as described above. In some implementations, performing the one or more actions includes one or more of providing a notification to a driver of a vehicle about an instability of the one or more objects, or providing a notification to a manager of a vehicle about the instability of the one or more objects. In some implementations, performing the one or more actions includes one or more of scheduling a driver of a vehicle for driver education training based on an instability of the one or more objects, or retraining one or more of the first model, the second model, or the large language model based on the one or more of the description, the first stability, the second stability, or the third stability.

In some implementations, process 500 includes receiving surrounding video data associated with a vehicle event and sensor data identifying a speed, an acceleration, and an angular velocity of a vehicle, and utilizing the surrounding video data and the sensor data to identify the vehicle event. In some implementations, performing the one or more actions includes utilizing the vehicle event to determine a cause of an instability of the one or more objects. In some implementations, process 500 includes processing the image segments and the first stability, with the second model, to confirm whether the first stability is correct. In some implementations, process 500 includes removing, from the image segments, one or more image segments that include a quantity of pixels less than a threshold.

In some implementations, process 500 includes utilizing the LLM to classify an instability of the cargo. In some implementations, process 500 includes analyzing the cargo data, with an artificial intelligence model, to identify the one or more objects in the cargo data. In some implementations, process 500 includes receiving surrounding video data associated with a vehicle and sensor data identifying a speed, an acceleration, and an angular velocity of the vehicle, and detecting a vehicle event based on the surrounding video data and the sensor data, wherein the image segments are processed by the first model and the second model based on detecting the vehicle event.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, cargo data associated with cargo;
segmenting, by the device, one or more objects identified in the cargo data to generate image segments;
processing, by the device, the image segments, with a first model, to determine a first stability of the one or more objects;
processing, by the device, the image segments, with a second model, to determine a second stability of the one or more objects;
combining, by the device, the first stability and the second stability to generate a third stability;
utilizing, by the device, a large language model with the image segments and one of the first stability, the second stability, or the third stability to generate a description of the one or more objects; and
performing, by the device, one or more actions based on one or more of the description, the first stability, the second stability, or the third stability.

2. The method of claim 1, wherein performing the one or more actions comprises one or more of:
providing a notification to a driver of a vehicle about an instability of the one or more objects; or
providing a notification to a manager of a vehicle about the instability of the one or more objects.

3. The method of claim 1, wherein performing the one or more actions comprises one or more of:
scheduling a driver of a vehicle for driver education training based on an instability of the one or more objects; or
retraining one or more of the first model, the second model, or the large language model based on the one or more of the description, the first stability, the second stability, or the third stability.

4. The method of claim 1, further comprising:
receiving surrounding video data associated with a vehicle event and sensor data identifying a speed, an acceleration, and an angular velocity of a vehicle; and
utilizing the surrounding video data and the sensor data to identify the vehicle event.

5. The method of claim 4, wherein performing the one or more actions comprises:
utilizing the vehicle event to determine a cause of an instability of the one or more objects.

6. The method of claim 1, further comprising:
processing the image segments and the first stability, with the second model, to confirm whether the first stability is correct.

7. The method of claim 1, further comprising:
removing, from the image segments, one or more image segments that include a quantity of pixels less than a threshold.

8. A device, comprising:
one or more processors configured to:
receive cargo data associated with cargo;
segment one or more objects identified in the cargo data to generate image segments;
remove, from the image segments, one or more image segments that include a quantity of pixels less than a threshold;
process the image segments, with a first model, to determine a first stability of the one or more objects;
process the image segments, with a second model, to determine a second stability of the one or more objects;
combine the first stability and the second stability to generate a third stability;
utilize a large language model with the image segments and one of the first stability, the second stability, or the third stability to generate a description of the one or more objects; and
perform one or more actions based on one or more of the description, the first stability, the second stability, or the third stability.

9. The device of claim 8, wherein the one or more processors, to process the image segments, with the first model, to determine the first stability of the one or more objects, are configured to:
filter the image segments to remove one or more image segments;
re-center the image segments to account for camera movement by a camera associated with the cargo;
join two of the image segments together that correspond to an object of the one or more objects; and
match the image segments, after filtering, recentering, and joining, to determine the first stability of the one or more objects.

10. The device of claim 8, wherein the one or more processors, to process the image segments, with the first model, to determine the first stability of the one or more objects, are configured to:
utilize a similarity function to compare the image segments across multiple frames of the cargo data to determine the first stability of the one or more objects.

11. The device of claim 8, wherein the one or more processors, to process the image segments, with the second model, to determine the second stability of the one or more objects, are configured to:
utilize a center-of-mass analysis with the image segments to calculate and compare angles associated with the one or more objects and to determine the second stability of the one or more objects based on the angles.

12. The device of claim 8, wherein the one or more processors are further configured to:
utilize the large language model to classify an instability of the cargo.

13. The device of claim 8, wherein the one or more processors are further configured to:
analyze the cargo data, with an artificial intelligence model, to identify the one or more objects in the cargo data.

14. The device of claim 8, wherein the one or more processors are further configured to:
receive surrounding video data associated with a vehicle and sensor data identifying a speed, an acceleration, and an angular velocity of the vehicle; and
detect a vehicle event based on the surrounding video data and the sensor data,
wherein the image segments are processed by the first model and the second model based on detecting the vehicle event.

15. A non-transitory computer-readable medium storing a set of instructions, the set of instructions comprising:
one or more instructions that, when executed by one or more processors of a device, cause the device to:
receive cargo data associated with cargo;
segment one or more objects identified in the cargo data to generate image segments;
process the image segments, with a first model, to determine a first stability of the one or more objects;
process the image segments and the first stability, with a second model, to confirm whether the first stability is correct;
process the image segments, with the second model, to determine a second stability of the one or more objects;
combine the first stability and the second stability to generate a third stability;
utilize a large language model with the image segments and one of the first stability, the second stability, or the third stability to generate a description of the one or more objects; and
perform one or more actions based on one or more of the description, the first stability, the second stability, or the third stability.

16. The non-transitory computer-readable medium of claim 15, wherein the one or more instructions, that cause the device to perform the one or more actions, cause the device to one or more of:
provide a notification to a driver of a vehicle about an instability of the one or more objects;
provide a notification to a manager of a vehicle about the instability of the one or more objects;
schedule a driver of a vehicle for driver education training based on an instability of the one or more objects; or
retrain one or more of the first model, the second model, or the large language model based on the one or more of the description, the first stability, the second stability, or the third stability.

17. The non-transitory computer-readable medium of claim 15, wherein the one or more instructions further cause the device to:
receive surrounding video data associated with a vehicle event and sensor data identifying a speed, an acceleration, and an angular velocity of a vehicle;
utilize the surrounding video data and the sensor data to identify the vehicle event; and
utilize the vehicle event to determine a cause of an instability of the one or more objects.

18. The non-transitory computer-readable medium of claim 15, wherein the one or more instructions, that cause the device to process the image segments, with the first model, to determine the first stability of the one or more objects, cause the device to:
filter the image segments to remove one or more image segments;
re-center the image segments to account for camera movement by a camera associated with the cargo;
join two of the image segments together that correspond to an object of the one or more objects; and
match the image segments, after filtering, recentering, and joining, to determine the first stability of the one or more objects.

19. The non-transitory computer-readable medium of claim 15, wherein the one or more instructions, that cause the device to process the image segments, with the second model, to determine the second stability of the one or more objects, cause the device to:
utilize a center-of-mass analysis with the image segments to calculate and compare angles associated with the one or more objects and to determine the second stability of the one or more objects based on the angles.

20. The non-transitory computer-readable medium of claim 15, wherein the one or more instructions further cause the device to:
utilize the large language model to classify an instability of the cargo.
